(19) United States
(12) Patent Application Publication
(10) Pub. No.: US 2011/0189067 A1
(43) Pub. Date: Aug. 4, 2011

(54) SORBENT FOR CARBON DIOXIDE

(76) Inventor: William B. Retallick, West Chester, PA (US)

(21) Appl. No.: 13/009,369

(22) Filed: Jan. 19, 2011

Related U.S. Application Data
(60) Provisional application No. 61/300,497, filed on Feb. 2, 2010.

(51) Int. Cl. B01D 53/62; B01J 20/22

(52) U.S. Cl. 423/230; 502/404

(57) ABSTRACT

A sorbent for carbon dioxide is made by combining a strong alkaline material with an acidic material, and an adhesive medium. The components are mixed together, cut into pieces, and sieved. The resulting composition absorbs carbon dioxide from a gas stream, and can be regenerated by the application of steam. In the preferred embodiment, the alkaline material is calcium hydroxide, and the acidic material is potassium bisulfate. The ratio of the weight of the alkaline material to that of the acidic material, before mixing of the components, is preferably in the range of about 9-20.

### CROSS-REFERENCE TO PRIOR APPLICATION

Priority is claimed from U.S. Provisional Patent Application Ser. No. 61/300,497, filed Feb. 2, 2010, the disclosure of which is hereby incorporated by reference.

### BACKGROUND OF THE INVENTION

The present invention relates to the field of removal of carbon dioxide from a gas stream, such as a combustion gas. In particular, the present invention comprises a composition which absorbs carbon dioxide, and which can be regenerated for further use.

Carbon dioxide is weakly acidic. Thus, the medium that absorbs carbon dioxide must be strongly basic. On the other hand, if the sorbent is too strongly basic, the carbon dioxide will be held so strongly by the sorbent that it is difficult to remove the carbon dioxide from the sorbent (i.e. it is difficult to regenerate the sorbent). Therefore, the present invention combines a strongly basic material with an acidic material which partially neutralizes the base. The acid must have low volatility.

### SUMMARY OF THE INVENTION

The present invention comprises a sorbent for carbon dioxide. The sorbent is made by mixing a strong alkaline material with an acidic material and an adhesive medium, thereby forming a paste. The paste is dried and chopped into fragments. The fragments are then passed through a sieve. The sieved fragments comprise the sorbent.

In a preferred embodiment, the strong alkaline material comprises calcium hydroxide, and the acidic material comprises potassium bisulfate. The adhesive medium can be molasses.

In a preferred embodiment, the ratio of the weight of the alkaline material to the weight of the acidic material, before mixing, is in the range of about 9-20.

The prevent invention therefore has the primary object of providing a composition which is useful as a sorbent for carbon dioxide.

The invention has the further object of providing a sorbent which removes carbon dioxide from a gas stream.

The invention has the further object of providing a sorbent for carbon dioxide, which sorbent can be regenerated for re-use.

The reader skilled in the art will recognize other objects and advantages of the present invention, from a reading of the following detailed description of the invention, and the appended claims.

### DETAILED DESCRIPTION OF THE INVENTION

The present invention comprises a composition which is used to remove carbon dioxide from a gas stream, wherein the composition may be regenerated for further use.

The sorbent material includes a basic material in combination with an acidic material, such that the acidic material partially neutralizes the basic material.

In one example, the basic sorbent material is calcium hydroxide, and the acidic material is potassium bisulfate. One possible composition is formed as follows.

### EXAMPLE 1

Mixed together in a bowl are 9.0 grams of calcium hydroxide, about 2.4-2.8 grams of KHSO₄ (potassium bisulfate), 2.0 grams of molasses, and water sufficient to form a paste. The paste is dried in the bowl and then is chopped into fragments with a knife or chisel. The fragments are passed through a pair of sieves, arranged in series, such that the fragments pass through a sieve of 14 mesh and are held by a sieve of 30 mesh. The fragments comprise the sorbent.

The sorbent compositions shown in Examples 2 and 3 are considered more preferable. Both compositions use proportionately less acid material than the composition of Example 1.

### EXAMPLE 2

The procedure of Example 1 was repeated, with 9.00 grams of calcium hydroxide, 2.15 grams of molasses, and 0.95 grams of potassium bisulfate.

### EXAMPLE 3

Example 2 was repeated, except that the amount of potassium bisulfate was 0.50 grams.

In Example 2, the ratio of the amount of calcium hydroxide to the amount of potassium bisulfate was about 9.47. In Example 3, this ratio was 18.

In the general case, the preferred ratio of basic material to acidic material should be in the range of about 9-20. However, values outside of this range may still be workable.

The sorbent made as described above can absorb up to about 4% of its weight in carbon dioxide.

The sorbent can be regenerated with hot steam, having a temperature of about 350° C. or greater. Passing the steam over the sorbent causes the carbon dioxide to be released from the sorbent, so that the sorbent is substantially free of carbon dioxide, and so that the sorbent can be used again for removing carbon dioxide from a stream.

In the above example, calcium hydroxide is strongly basic, so much so that the carbon dioxide, once absorbed, would be difficult to desorb. Thus, the calcium hydroxide is partially neutralized with potassium bisulfate, which in this example is the acid with low volatility.

In the above example, molasses was used as a medium for forming the paste. Other materials could be used instead.

In the more general case, the present invention comprises a sorbent formed of a strong alkaline material, and an acidic material, the alkaline material and the acidic material being mixed together with a medium, preferably a medium having adhesive properties, to form a paste, the paste being dried, chopped into fragments, and passed through a sieve. The sieved fragments comprise the sorbent.

The invention is not intended to be limited to a particular process for making the sorbent, but is intended to cover the sorbent however it is made. The invention thus may be modified, as will be apparent to the reader skilled in the art. Such modifications should be considered to be within the spirit and scope of the following claims.

What is claimed is:

1. A sorbent for carbon dioxide, comprising a strong alkaline material, and an acidic material, the alkaline material and the acidic material being mixed together with an adhesive medium and formed into a plurality of fragments.

2. The sorbent of claim 1, wherein the alkaline material comprises calcium hydroxide, and the acidic material comprises potassium bisulfate.

3. The sorbent of claim 2, wherein the adhesive medium comprises molasses.

4. The sorbent of claim 1, wherein the ratio of a weight of the alkaline material to a weight of the acidic material is in a range of about 9-20.

5. A sorbent for carbon dioxide, made by the method comprising the steps of:
a) mixing a strong alkaline material with an acidic material and an adhesive medium, thereby forming a paste,
b) drying the paste and chopping the dried paste into fragments,
c) passing the fragments through at least one sieve, wherein the sieved fragments comprise the sorbent.

6. The sorbent of claim 4, wherein the alkaline material comprises calcium hydroxide.

7. The sorbent of claim 6, wherein the acidic material comprises potassium bisulfate.

8. The sorbent of claim 7, wherein the adhesive medium comprises molasses.

9. The sorbent of claim 5, wherein the ratio of a weight of the alkaline material to a weight of the acidic material is in a range of about 9-20.

10. A method of absorbing carbon dioxide from a gas stream, comprising:
forming a sorbent by the method comprising the steps of:
a) mixing a strong alkaline material with an acidic material and an adhesive medium, thereby forming a paste,
b) drying the paste and chopping the dried paste into fragments,
c) passing the fragments through at least one sieve, wherein the sieved fragments comprise the sorbent, and
contacting the sorbent with a gas stream, the gas stream containing carbon dioxide, wherein the sorbent absorbs at least some of the carbon dioxide.

11. The method of claim 10, further comprising regenerating the sorbent by passing steam over the sorbent so as to cause absorbed carbon dioxide to be released from the sorbent.

12. The method of claim 10, further comprising selecting the alkaline material to be calcium hydroxide, and selecting the acidic material to be potassium bisulfate.
